(19) United States
(12) Patent Application Publication
(10) Pub. No.: US 2003/0137150 A1
(43) Pub. Date: Jul. 24, 2003

(54) Conversion device for nature energy at sea

(76) Inventor: Chao-Fu Shu, Taipei (TW)

Correspondence Address: Chao-Fu Shu, PO Box 82-144, TAIPEI, TW

(21) Appl. No.: 10/052,753

(22) Filed: Jan. 23, 2002

(51) Int. Cl. H02P 9/04; F03B 13/00

(52) U.S. Cl. 290/54

(57) ABSTRACT

A conversion device for nature energy at sea is disclosed. The device effectively accesses low energy wave and wind and converts the energy into operable energy for application. The device is applicable to the change of tide and the size of wind power and is suitable for use at the shallow sea side.

### BACKGROUND OF THE INVENTION

(a) Field of Technical Art

The present invention relates, in general, to a conversion device for converting nature energy at sea, such as wave energy and wind energy, to other useful energy to be used at a later time.

(b) Brief Description of the Prior Art

In the prior art various types of energy extraction and conversion devices have been proposed. For example, Taiwan Patent Nos. 246162, 252182, 270,962, and 325820, and U.S. Pat. Nos. 5,708,305, 5,808,368, 4,101,244, etc disclose devices used in producing useful energy such as electrical energy by converting energy of wind, water and wave.

Taiwan Patent No. 246162 discloses a generator powered by wave and the device can only be located at the wave retention wall and the push of the wave drives the turbine of the generator to produce useful electrical energy. The device is easily damaged by the strong wave impacted at the retention wall.

Taiwan Patent No. 252182 discloses a wave generator which utilizes power of the sea water to produce pressure within a tube to drive a turbine. The device is not efficient when the seawater is at low tide.

Taiwan Patent No. 270962 discloses a power system powered by accumulated nature energy sources which makes use of a device vibrating in accordance with the wave to produce energy, however, at high tide or low tide, the cylinder and the linking rod will not be able to operate normally and therefore the conversion efficiency is low.

Taiwan Patent No. 325820 discloses a float-powered generator, which can only convert horizontal direction wave movement to useful energy U.S. Pat. No. 5,708,305 discloses a wave energy conversion system for capturing the energy of ocean waves comprising: a support platform having a base and tiers spaced at different heights above said base, each tier having means for rotatably supporting a horizontal arm at one end of said arm, said arms being of different lengths, another end of said arm significantly extended from said support platform, and having float means attached adjacent thereto, said another end of said arm also having means for receiving the force of ocean waves and current for transferring said force to said arms, said one end of said arms being attached to a compression means for compressing fluids, and having means for transferring said compressed fluids to a storage facility.

U.S. Pat. No. 5,808,368 discloses an ocean wave energy conversion device and the device comprises a float being attached by vertical mooring lines, or cables, to a pivoting lever device which is mounted on a submerged anchor. The lever device is oriented perpendicular to the shoreline, with one arm of the lever pointing shoreward and the other pointing upward. The shoreward pointing arm is almost horizontal in orientation and long enough to compensate for tidal variations. The lines from the float are attached to the end of the shoreward pointing am Vertical pull of the float will pull upward on the shoreward pointing arm and cause it to pivot about sealed bearings, which causes the upper arm of the lever device to rotate in a largely horizontal arc away from shore, thus pulling on the main drive line which is attached to the end of the upward pointing arm and which leads to shore. During wave troughs the float falls naturally and the lever device is returned to its prior position by the pull exerted on the main drive line by a falling weight which is located in the enclosed shore structure), in which an energy extraction device is also located. The shore structure has a device, which temporarily restrains upward motion of the float as waves pass under it, so that when released it travels upward for a greater distance and with more velocity than it would otherwise obtain.

U.S. Pat. No. 4,101,244 discloses a vertical axle paddle, wherein the vertical axle paddle motor including a support structure with a rotor mounted on the vertical axle, the rotor having a plurality of arms with paddle members pivotally attached to the end of the same. Each of the paddle members includes a plurality of adjustable vanes, which move from an open to a closed position within the paddle. Vane position in the paddles is controlled by a wind velocity and wind direction control, operating a pair of cams forming a composite cam surface which is engaged by cam followers on each of the rotor arms associated separately with motors on the paddle, to adjust the position of the vanes within the paddles for maximum efficiency in rotation. The wind velocity cam may be adjusted relative to the wind direction cam to increase the amount of time the vanes of the paddles are held in an open position to reduce and stabilize rotation of the rotor. The wind velocity cam may also be adjusted by a separate motor means to prevent any of the vanes from moving to a closed position causing cessation of rotor rotation.

In view of the above prior art, the efficiency of energy conversion is in consistent with respect to the level of tide and the strength of wave. Besides, some devices, which employed are complicated in structure and the mounting of the devices is not secured in view of strong wave.

Therefore, what is needed is a system for capturing the energy of ocean or sea waves and wind, which is cost effective and must necessarily eliminate the drawbacks found in the prior art.

### SUMMARY OF THE INVENTION

Accordingly it is an object of the present invention to provide a conversion device for nature energy at sea having an upper layer being a wind energy conversion means and a lower layer being a wave energy conversion means, characterized in that both means are supported by a support body having one end being mounted into the seabed, and the middle section is connected to other support bodies by a liking rod, the wind conversion means includes three independent rotating mechanism mounted on the support body and are equally distributed and the rotating mechanism accesses wind energy by vertical rotating paddle to drive a transmission shaft to obtain power; and the wave energy conversion means includes 4 independent conversion mechanisms, and the mechanism is a combination of a support body, a float and a floating cylinder, the surrounding of the support boy is connected to floats and a transmission mechanism is provided to the float and the floating cylinder is at the sea level, one end of the floating cylinder is connected to a teeth strap in combination with the transmission mechanism to produce high pressure energy via the transmission mechanism, thereby the produced high pressure air energy is transmitted to the coast via air delivery tube.

Yet another object of the present invention is to provide a conversion device for nature energy at sea, wherein the device is connected by directional paddle and a cam and bearing is mounted to the upper end of the vertical rotating shaft, a sliding slot is provided on the cam and the top and bottom ends of the rotating shaft are combined with two bearings each supported by a support rod, and the support rod and the support body are connected to form a body, and the rotating shaft rotates vertically, a plurality groups of paddles are mounted to the rotating shaft and the end terminal of the rotating shaft is connected to crank wheel driving an air pump to produce high pressure air energy, the paddle has a combination of a bearing and a shaft cover and the shaft cover is actuated by a linking rod such that the paddle is at vertical position when at clock wise wind direction and at horizontal position when at counter clockwise wind direction, the top end of the linking rod is connected to a supporting point of a crankshaft board having one end connected to a pulley which slides within the sliding slot to actuate the crankshaft board to cause the paddle to vary angle change, and the crankshaft board is mounted to the rotating shaft and rotates simultaneously with the paddle.

A further object of the present invention is to provide a conversion device for nature energy at sea, wherein the paddle is provided with a base seat and the wind-blocking board and pulling force spring, and the base seat is provided with a plurality of holes spaced apart in rows and the two sides of the base seat are provided with a sliding slot, and one end of the pulling force spring is mounted to the base seat of the paddle and the other end is mounted to the wind-blocking board, and the wind-blocking board is provided with a plurality of holes which are spaced apart in rows, when the wind-blocking board is located at the sliding slot of the base seat the two holes are not in alignment and when the wind blocking board is away from the pulling force spring, the two holes are stacked to form leakage.

Still another object of the present invention is to provide a conversion device for nature energy at sea, where the sides of the support body is surrounded by four floats connected to form a center hole which is used to mount to the support body, the upper layer of the float is provided with a transmission mechanism which is connected to a teeth strap by means of a hole, the lower layer of the float is connected to an elongated floating cylinder floats at sea level, and the inner side of the lower layer of the float is provided with pulley to urge one side of the support body.

Other objects and advantages of the present invention will become more apparent from the following description taken in conjunction with the accompanying drawings.

### BRIEF DESCRIPTION OF THE DRAWINGS

FIG. 1 is a schematic view showing a conversion device for natural energy at sea in accordance with the present invention.

FIG. 2 is a schematic view showing a float-type wave energy conversion device in accordance with the present invention.

FIG. 3 is a sectional view along line AB of FIG. 2 in accordance with the present invention.

FIG. 4 is a schematic view showing the raising of the float by the wave in accordance with the present invention.

FIG. 5 is a schematic view showing the lowering of the float by the wave in accordance with the present invention.

FIGS. 6 and 7 respectively show the top and front views of the transmission mechanism of power in accordance with the present invention.

FIG. 8 is a schematic view showing the wave energy conversion device mounted at the seabed in accordance with the present invention.

FIG. 9 is a top view of the wave energy conversion device in accordance with the present invention.

FIG. 10 is a top view showing a conversion device for wind energy in accordance with the present invention.

FIG. 11 is a sectional view of the wind energy conversion device in accordance with the present invention.

FIG. 12 is a schematic view showing the swinging position of the paddle and the wind direction in accordance with the present invention.

FIG. 13 is an extended view of the cam slot in accordance with the present invention.

FIG. 14 is a control diagram for the swinging direction of the paddle in accordance with the present invention.

FIG. 15 is a top view of the paddle at the maximum wind resistance in accordance with the present invention.

FIG. 16 is the top view of the base seat of the in accordance with the present invention.

FIG. 17 is a top view of the wind-blocking board in accordance with the present invention.

FIG. 18 is a top view of the paddle at minimum wind resistance in accordance with the present invention.

### DETAILED DESCRIPTION OF THE PRESENT INVENTION

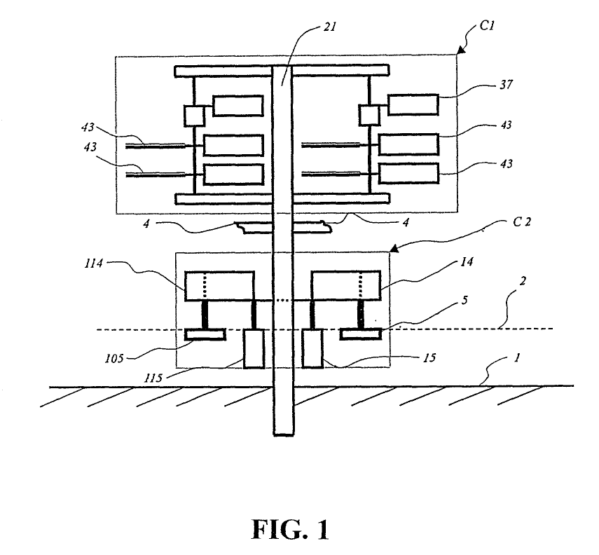

FIG. 1 is a schematic view showing a conversion device for natural energy at sea in accordance with the present invention. The device is divided into a top layer and a bottom layer. The top layer C1 is a wind energy conversion device for accessing wind energy and is then converted into high-pressure air energy. The bottom layer C2 is a float-type wave energy conversion device to access wave energy and is then converted into high-pressure air energy. These two devices are supported by a supporting body 21 having one end being mounted onto the seabed 1 and the middle section is connected to other support bodies 21 by an interlinking rod 4. These two devices can be used for the conversion of wind energy or wave energy.

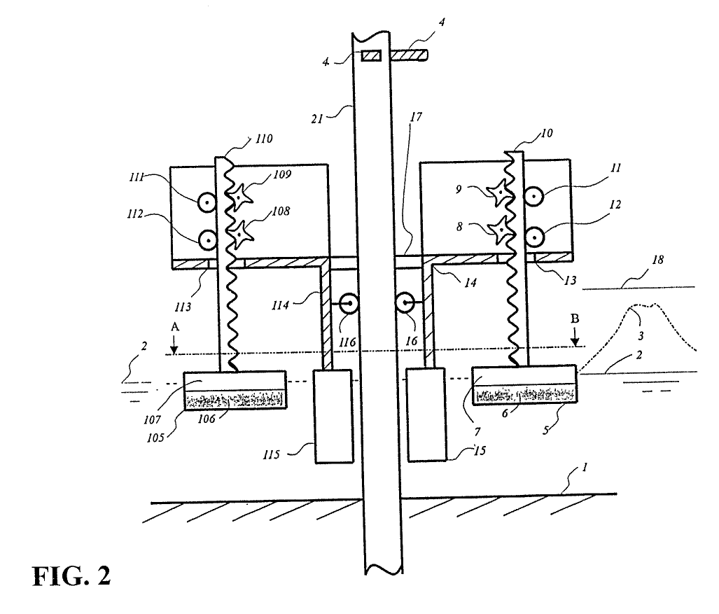

FIG. 2 is a schematic view showing a float-type wave energy conversion device in accordance with the present invention.

A support body 21, a float, a flat floating cylinder 5 and a transmission mechanism support the device. One end of the support body 21 is mounted onto the seabed 1 and the end point of a teeth strap 10 is connected to the floating cylinder 5, and the floating cylinder 5 consists of a liquid chamber 6 and an air chamber 7. The liquid chamber 6 is used to contain water and the teeth strap 10 and the weight of the housing of the floating cylinder 5 are carried by the discharging volume of the air chamber 7. As a result the floating cylinder 5 can float the weight of the housing of on the sea level 2.

One end point of the teeth strap 10 is connected to the floating cylinder 5 and the teeth strap 10 is extended to through hole 13 and the teeth face and the gear 8 and gear 9 are engaged with each others, and the back of the teeth and pulley 11 and pulley 12 are combined with each others. Thus, the teeth strap 10 moves up and moves down together with the floating cylinder 5, the weight of the housing of and the gear 8 and 9 are driven.

As shown in FIG. 2, the gear 8 and 9, the pulley 11 and 12 are mounted to the float 14. The lower layer of the float 14 is connected to an elongated floating cylinder 15, and the inner side of the bottom layer is a pulley 16 supporting one side of the support body 3. Thus the floating cylinder 15 will support the weight of the float 14, and the floating body 15 is floated at sea level 2.

As shown in FIG. 2, the floating cylinder 105 is connected to the end point of the teeth strap 110, and the floating cylinder 105 consists of a liquid chamber 106 and air chamber 107. The chamber 106 is filled with seawater, and the teeth strap 110 and the weight of the housing of the floating cylinder 105 are carried by the discharging volume of the air chamber 107 and the floating cylinder 105 can float on sea level 2.

As shown in FIG. 2, one end point of the teeth strap 110 and the floating cylinder 105 are connected and the teeth strap 110 is extended to the through hole 113, and the teeth face and the gear 108 and 109 are engaged with each others, and the back of the teeth and the pulley 111 and the pulley 112 are combined with each others. Thus, the teeth strap 110 moves up and move down together with the floating cylinder 105 and the gear 108 and 109 are thus driven.

As shown in FIG. 2, the gear 108 and 109, the pulley 111 and 112 are mounted at the float 114. The lower layer of the float 114 is connected to an elongated floating cylinder 115, and the inner side of the bottom layer is a pulley 116 supporting one side of the support body 21. Thus the floating cylinder 115 will support the weight of the support body 21 and the floating cylinder 115 floats on the sea level 2.

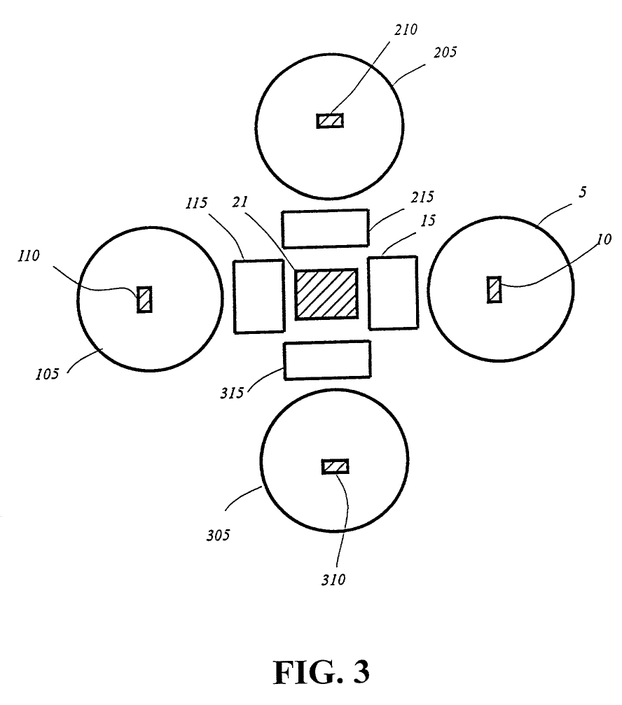

As shown in FIG. 2, the side of the support body 21 can be mounted with a plurality of floats, for instance the float 14 and 114. These floats 14, 114 can be connected to form one body and the center of the bodies can be surrounded to form a hole 17 allowing the connection to the support body 21, which is shown in FIG. 3. At the side of the support body 21, there are altogether 4 groups of floats, wherein there are floating cylinder 5, float 205, and float 305 connected to the teeth strap. Under same condition of height and density, as the cross-sectional area is smaller the carrying volume is larger and therefore a larger float is needed in order to keep afloat.

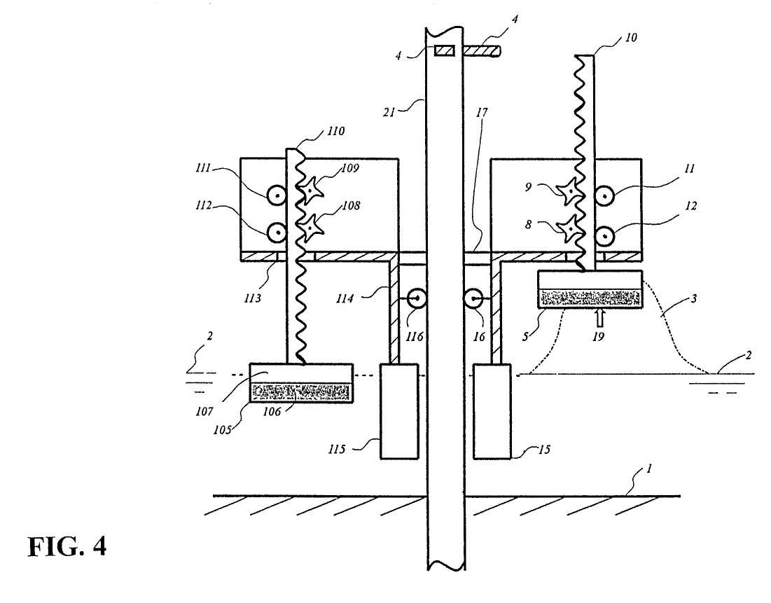

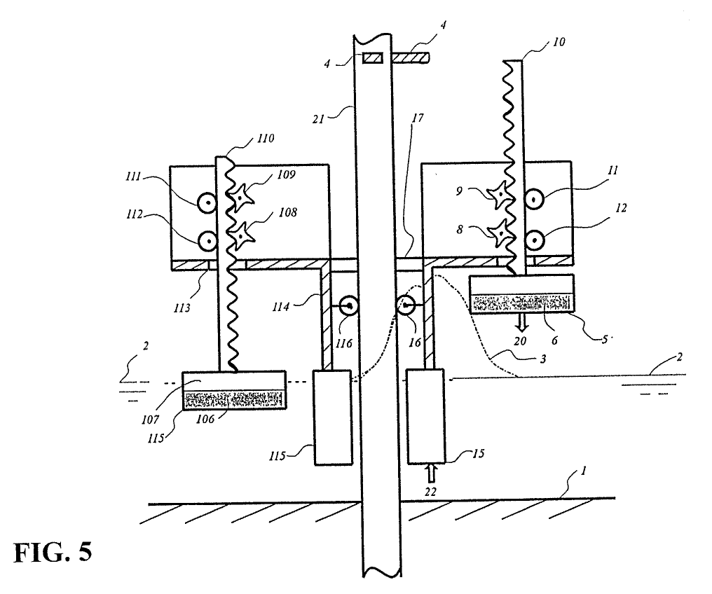

As shown in FIG. 2, if the height of the tide changes, all the floats will change and maintain to be at sea level. Thus under the wave condition, the floats will produce relative motion and the float-type wave energy conversion device will adapt to the height change of the tide. This is shown in FIGS. 4 and 5, where FIG. 4 is a schematic view showing the rising of the float by the wave in accordance with the present invention, and FIG. 5 is a schematic view showing the lowering of the float by the wave in accordance with the present invention.

As shown in FIG. 4, if wave 3 has proceeded to the floating cylinder 5, the cross-sectional area of the floating cylinder 5 is large and therefore a slight wave will lift up the floating cylinder 5. For instance, if the lifting force 19 pushes upward the floating cylinder 5, the teeth strap 10 will rise and the gear 8 and 9 will be driven to rotate counter-clockwise.

When the wave 3 passes the floating cylinder 5, as shown in FIG. 5, the float withstands the lowering of the wave. This is because the floating force of the floating cylinder 5 disappears and the lowering force 20 of the float including the carrying load (teeth strap and the weight of the housing of the float) and the weight of the seawater contained in the liquid chamber 6. As a result the lowering force 20 must be larger than the lifting force 19, and at the same time, the float 15 will also withstand the lifting force 22 of the floating force. However, the float is connected to other floats, and thus the force will only cause the pulley 16 to urge against the support body 21, and the float body 14 remains the original shape. When the floating cylinder 5 is lowered as a result of the lowering force 20, the teeth strap 10 will be lowered to drive the gear 8 and 9 to rotate clockwise.

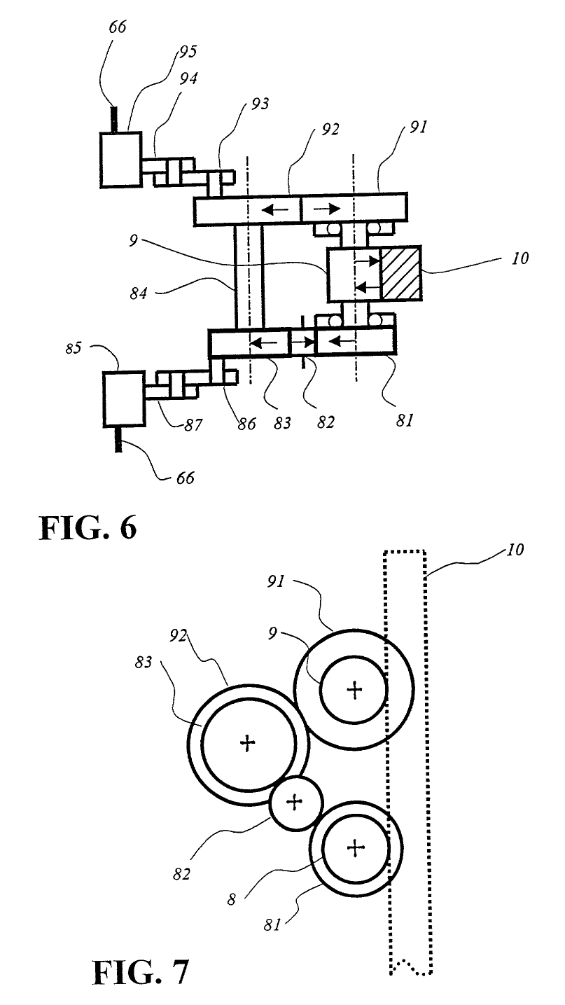

In FIG. 2, the rising and lowering of the teeth strap 10 follow that of the floating cylinder 5 and the transmission of the power is shown in FIGS. 6 and 7. The float body 14 supports the transmission mechanism, and the teeth strap 10 drives the gear 8 and 9 and the gear 9 and the free gear 91 are on the same axle and connected. The free gear is a unidirectional gear and similarly gear 8 and free gear 81 are at the same axle and connected and the free gear 81 is a undirectional gear.

In FIGS. 6 and 7, the free gear 91 and gear 92 are connected and the gear 92 is fixed to the shaft 84. The gear 92 drives the crankshaft 93 and the power via a linking rod 94 to push the air pump 95 and the energy is converted into high-pressure air energy, which is transmitted via an air delivery tube 66. The free gear 81 and the gear 82 are in engaged with each other and gear 82 and gear 83 are in engagement, and gear 83 is fitted to the shaft 84. Gear 83 drives the crankshaft 86 and the power via a linking rod 87 pushes the air pump 85. The energy is converted into high-pressure air energy and is delivered via the air delivery tube 66.

As shown in FIGS. 6 and 7, when the teeth strap 10 rises, gear 8 and gear 9 rotate counterclockwise, and the gear 8 and free gear 81 rotate at the same shaft but gear 9 and the free gear 91 are not in engagement and the power of the rising teeth strap 10 will be transmitted to the free gear and via gear 82 to gear 83 to drive shaft 84. Thus the gear 92 drives the air pump 95 to produce high-pressure air energy, which is delivered via an air delivery tube 66.

As shown in FIGS. 6 and 7, when the teeth strap 10 is lowered, gear 8 and gear 9 rotate clockwise, and the gear 9 and free gear 91 rotate at the same shaft but gear 8 and the free gear 81 are not in engagement and the power of the lowering teeth strap 10 will be transmitted to the free gear 91 and via gear 92 to drive the crank shaft 93, and the power via the linking shaft 94 to drive the air pump 95 to produce high pressure air energy air which is delivered via an air delivery tube 66. At the same time, the shaft 84 of the gear 92 will drive the gear 83 to drive the air pump 85 so as to produce high-pressure air energy, which is delivered via an air delivery tube 66.

The power transmission for the rising and lowering of the teeth strap 110 accompanying the float 105 is the same with the power transmission of the transmission mechanism shown in FIGS. 6 and 7 and the converted energy is obtained as kinetic energy delivered via the air delivery tube 66.

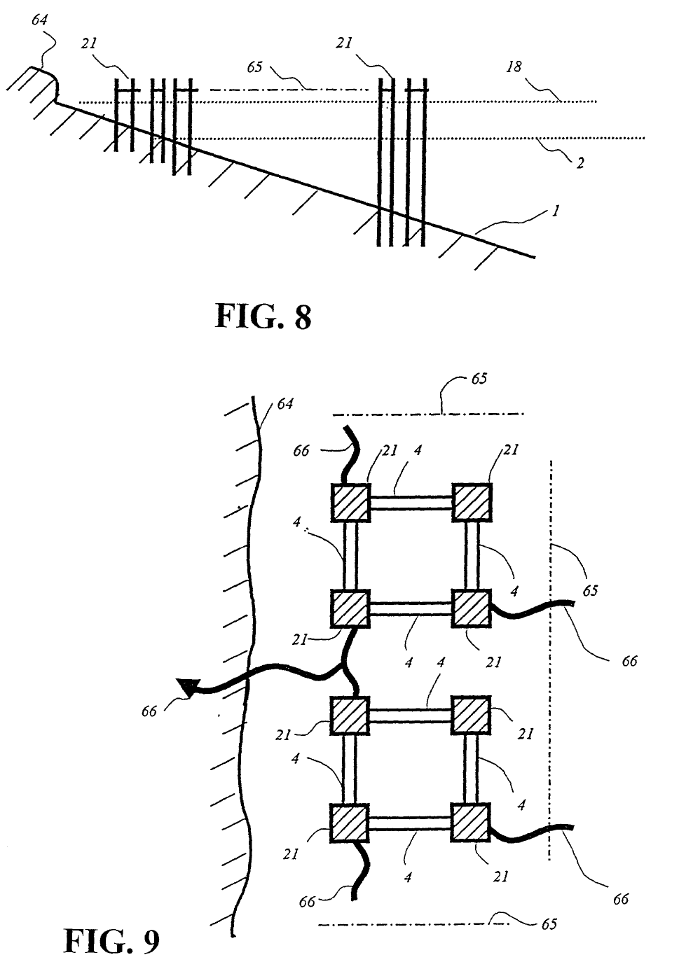

The support body 21 of the conversion device is connected with linking rod 4 to other support body 21 and is mounted to the seabed. As shown in FIG. 8, and FIG. 9, wherein FIG. 8 is a schematic view showing the wave energy conversion device mounted at the sea bed in accordance with the present invention, and FIG. 9 is a top view of the wave energy conversion device in accordance with the present invention. The support body 21 is mounted from the coast 64 and extended to the extended region 65. The energy is transmitted to the cost via the air delivery tube 66.

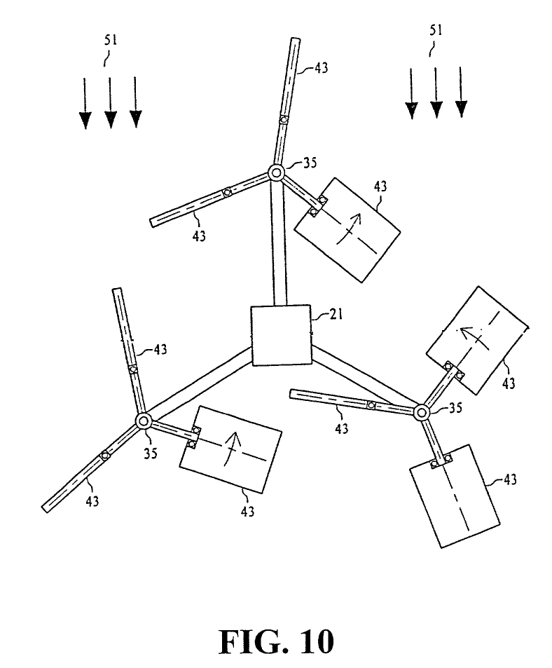

FIG. 10 is a top view showing a conversion device for wind energy in accordance with the present invention.

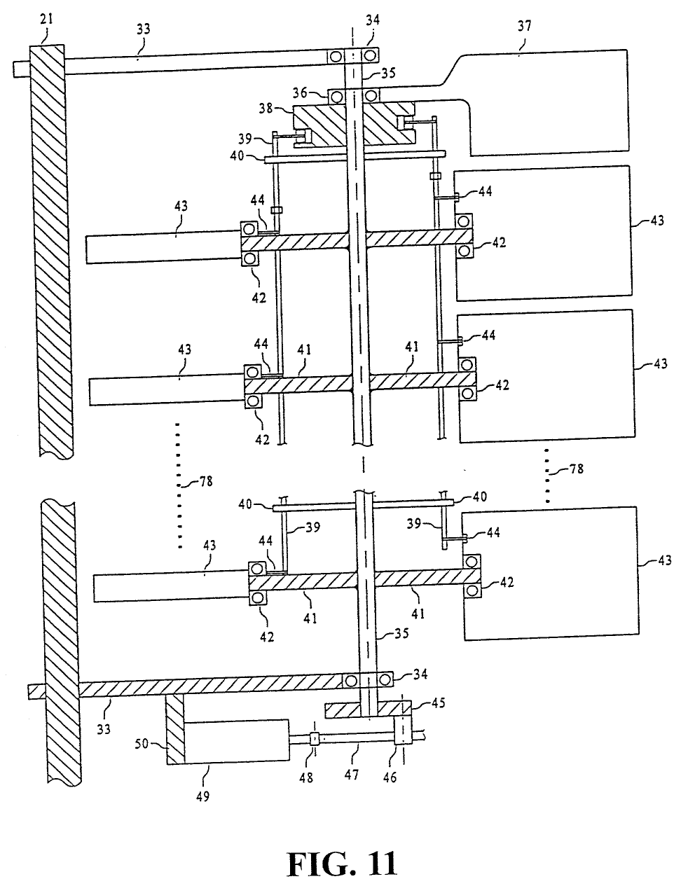

The device has three independent rotating mechanisms and each rotating mechanism is supported by support body 21 and is distributed at equal angle. The rotating mechanism employs paddle 43 to access energy and to drive the transmission shaft 35 to obtain power. The operation of the mechanism is based on the wind direction 51 and the function of the operation is shown in FIG. 11.

FIG. 11 is a sectional view of the wind energy conversion device in accordance with the present invention. The support body 21 and the support 33 are connected to form a rigid body and the transmission shaft 35 is supported at the branch shaft with a bearing 34. The direction paddle 37 and the cam 38 are connected to form a body and bearing 36 is connected to the transmission shaft 35. The branch shaft 40 supports the linking shaft 39 and the branch shaft 40 is fixed at the transmission shaft 35. One end of the branch shaft 40 is fixed to the transmission shaft 35 and therefore, the branched shaft 40 rotates with the transmission shaft 35. The other end of the branch shaft 41 combines with bearing 42 and the paddle 43 and therefore the paddle 43 rotates together with the transmission shaft 35. The linking shaft 39 drives the bearing 44 on the paddle 43 and the paddle 43 swings along the branched shaft 41.

The cam 45 is fixed to the transmission shaft 35, and crankshaft 46 is connected to the cam 45 and the linking shaft 47. One end of the lining shaft 47 is connected to the branched shaft 48 and the branched shaft 48 pushes the air pump 49. The branch rod 50 supports the air pump 49 so as to mount the pump 49 on the branch rod 33.

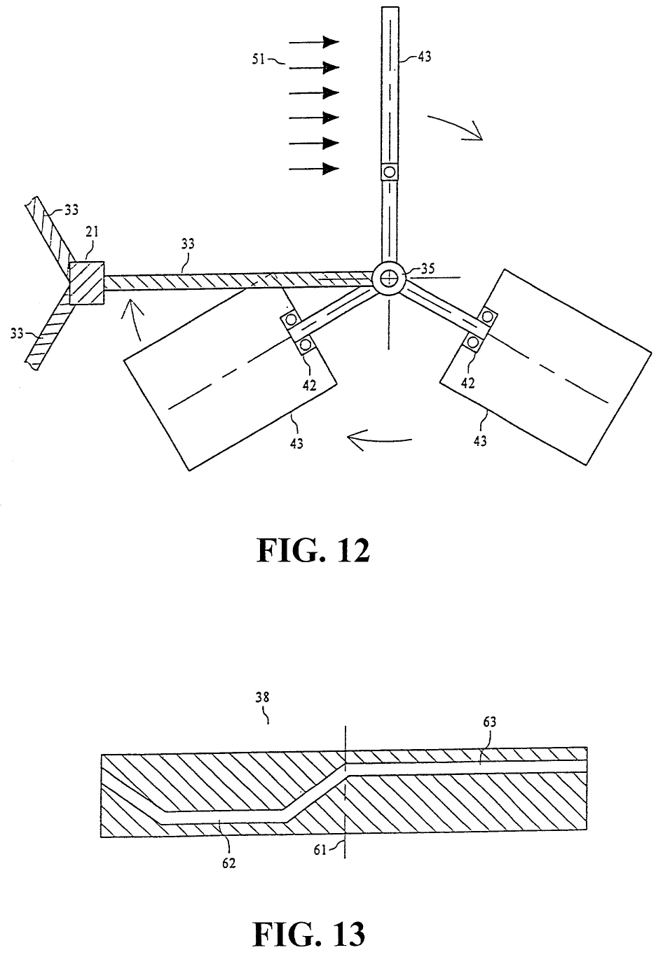

In FIG. 11, the directional paddle 37 and the paddle 43 are driven by wind. The directional paddle 37 follows the clockwise direction of the wind and stationed at one direction, and therefore the cam 38 is at a fixed position. The force of the wind will cause the paddle 43 to drive the transmission shaft 35 to rotate. When the transmission shaft 35 rotates, the paddle 43 is perpendicular to the wind direction and this will provide the maximum wind force. For paddle 43, which moves against wind of counter clockwise direction, the paddle 43 and the wind direction are at horizontal position. Thus, the paddle will withstand the minimum wind resistance. The extension 78 can adapt space requirements to increase the number of paddles 43. The swinging direction of the paddle with respect to the paddle is shown in FIG. 12.

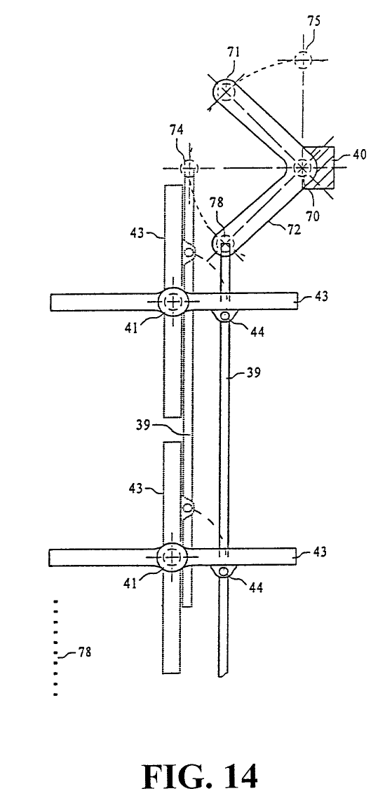

FIG. 12 is a schematic view showing the swinging position of the paddle and wind direction in accordance with the present invention. As shown in the FIG. 12, when the transmission shaft 35 rotates the paddle 43 under the clockwise wind direction 51, the paddle 43 is supported by bearing 42 and can be changed to perpendicular to the wind direction. The paddle 43 under counterclockwise wind direction can be converted into horizontal direction with the wind direction. The control of the swinging direction of the paddle is shown in FIGS. 13 and 14. FIG. 13 is an extended view of the cam slot in accordance with the present invention. FIG. 14 is a control diagram for the swinging direction of the paddle in accordance with the present invention. As shown in FIG. 13, the centerline 61 is half the length of the cam slot and the cam slot allows displacement of a pulley. When the pulley moves to the lowering slot 62, the pulley moves downward. When the pulley moves to the raising slot 62, the pulley moves upward.

As shown in FIG. 14, the linking rod 39 is connected to the crankshaft board 72 by the supporting point 73, and a branch shaft 40 supports the crankshaft board 72. The supporting point 70 is used as a turning shaft the branch shaft 40 is fitted to the transmission shaft 35 shown in FIG. 3. Thus, the linking rod 39 and the crankshaft board 72 will rotate simultaneously with the transmission shaft 35 shown in FIG. 11. Therefore when the pulley shaft moves to the raising slot 63 shown in FIG. 13, the supporting point 71 moves to point 75, supporting point 73 moves to the point 74, then the linking rod 39 will move to the raising position of the lining rod 39. The shaft cover 44 is fixed at the paddle 43, and the linking rod 39 drives shaft cover 44. Thus when the linking rod 39 moves to the linking rod 77, the paddle 43 moves to the vertical position of the paddle 76 and the paddle 43 and the wind direction become vertical to withstand the largest wind force. Thus when the supporting point 71 moves to the lowering slot 62 shown in FIG. 13, the linking rod 39 moves the paddle 43 to form a horizontal position. The extension 78 indicates the number of the linking rod 39 and the paddle 43 can be increased subsequently.

As shown in FIG. 11, there are 3 groups of combination of the linking rod 39 and the paddle 43 which are equally distributed. The directional paddle 37 will be fixed based on the clockwise wind direction. That is the cam 38 will become stationery, and therefore when the displacement of any group of combination of the linking rod 39 and the paddle 43 being at the clockwise direction the transmission shaft 35 will be provided with power. As a result, when the transmission shaft 35 rotates once, each paddle will convert the wind energy once. Finally, the power of the transmission shaft 35 is transmitted by the crankshaft 46 of the cam 45 via the linking rod 47 and the branch shaft 48 to the air pump 49 to provide kinetic energy of high-pressure air. As a result, when there is a change of strength of wind, the speed of the rotation of the transmission shaft 35 will change and the air pump 49 is able of changing the air into kinetic energy despite of the speed changes. The energy can be transmitted to the coast 64 via the air delivery tube 66 and is then accumulated to form high energy for effective application.

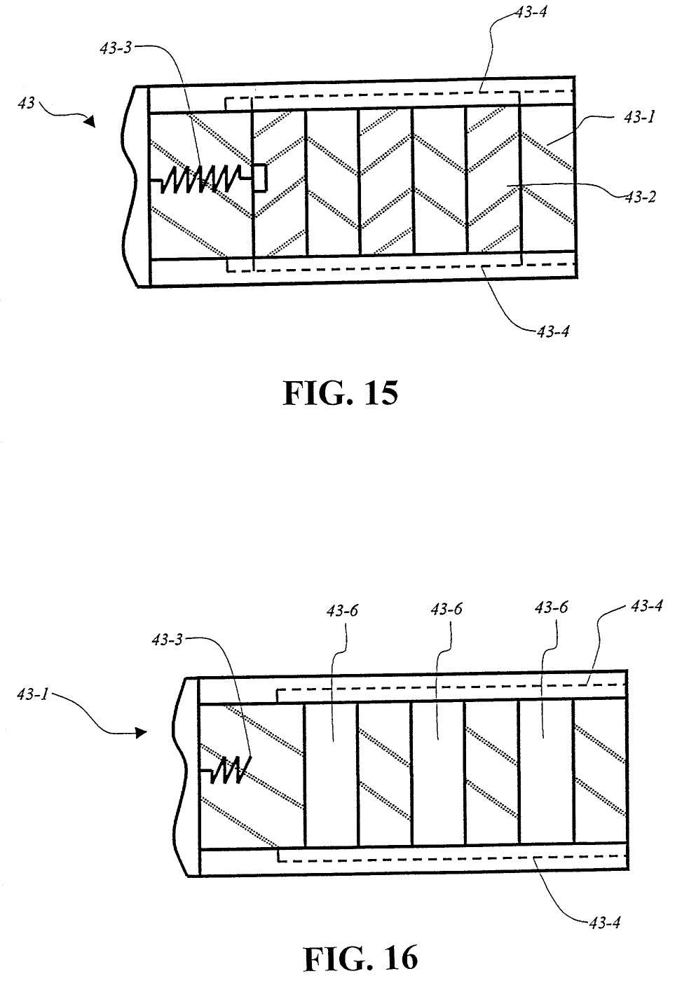

As shown in FIG. 12, the paddle 43 makes use of its large surface area to convert wind energy into high energy. When the strength of the wind energy exceeds load, the paddle 43 can automatically reduce the surface area to reduce the wind resistance so as to maintain normal operation of the wind energy conversion device. FIG. 15 is a top view of the paddle at the maximum wind resistance in accordance with the present invention.

As shown in FIG. 15, the function of the change of area of the paddle 43 is functioned by the combination of the base seat of the paddle 43-1, the wind resistance board 43-2 and the pulling spring 43-3. FIG. 16 is the top view of the base seat of the in accordance with the present invention.

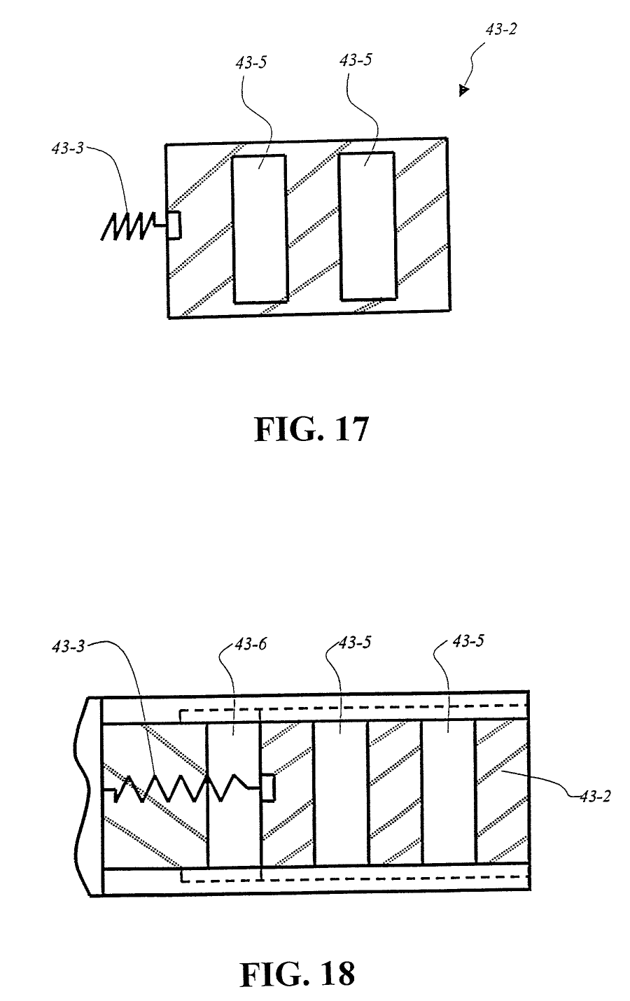

FIG. 17 is a top view of the wind-blocking board in accordance with the present invention. There are a plurality of holes 43-6 on the base seat of the paddle 43-1 and the holes are spaced in rows. The two sides of the base seat are provided with sliding slots 43-3 and one end of the pulling spring 43-3 is fixed at the base seat of the paddle 43-1 and the other end is fixed at the wind-blocking board 43-2. When the wind-blocking board 43-2 is provided with a plurality of holes 43-5 the holes are spaced apart and are arranged in rows. When the wind-blocking board 43-2 is located within the sliding slot 43-5, the hole 43-5 and 43-6 are not in alignment and the surface of the paddle 43 provides the larges wind resistance. When the strength of the wind exceeds the load, due to the centrifugal force of the wind-blocking board 43-2 being rotated exceeds the pulling force of the pulling spring 43-3 the wind-blocking board 43-2 will move externally and the hole 43-5 and 43-6 will stacked and leakage is thus formed and the wind resistance of the paddle 43 will be reduced so as to allow the conversion device to operate normally. When the change of wind resistance is the largest the hole 43-5 and 43-6 are the larges as shown in FIG. 18, wherein FIG. 18 is a top view of the paddle at minimum wind resistance in accordance with the present invention.

While the invention has been described with respect to preferred embodiments, it will be clear to those skilled in the art that modifications and improvements may be made to the invention without departing from the spirit and scope of the invention. Therefore, the invention is not to be limited by the specific illustrative embodiment, but only by the scope of the appended claims.

I claim:

1. A conversion device for nature energy at sea having an upper layer being a wind energy conversion means and a lower layer being a wave energy conversion means, characterized in that both means are supported by a support body having one end being mounted into the seabed, and the middle section is connected to other support bodies by a linking rod, the wind conversion means includes three independent rotating mechanism mounted on the support body and are equally distributed and the rotating mechanism accesses wind energy by vertical rotating paddle to drive a transmission shaft to obtain power; and the wave energy conversion means includes 4 independent conversion mechanisms, and the mechanism is a combination of a support body, a float and a floating cylinder, the surrounding of the support boy is connected to floats and a transmission mechanism is provided to the float and the floating cylinder is at the sea level, one end of the floating cylinder is connected to a teeth strap in combination with the transmission mechanism to produce high pressure energy via the transmission mechanism, thereby the produced high pressure air energy is transmitted to the coast via air delivery tube.

2. The device of claim 1, wherein the device is connected by directional paddle and a cam and bearing is mounted to the upper end of the vertical rotating shaft, a sliding slot is provided on the cam and the top and bottom ends of the rotating shaft are combined with two bearings each supported by a support rod, and the support rod and the support body are connected to form a body, and the rotating shaft rotates vertically, a plurality groups of paddles are mounted to the rotating shaft and the end terminal of the rotating shaft is connected to crank wheel driving an air pump to produce high pressure air energy, the paddle has a combination of a bearing and a shaft cover and the shaft cover is actuated by a linking rod such that the paddle is at vertical position when at clock wise wind direction and at horizontal position when at counter clockwise wind direction, the top end of the linking rod is connected to a supporting point of a crankshaft board having one end connected to a pulley which slides within the sliding slot to actuate the crankshaft board to cause the paddle to vary angle change, and the crankshaft board is mounted to the rotating shaft and rotates simultaneously with the paddle.

3. The device of claim 1, wherein the paddle is provided with a base seat and the wind-blocking board and pulling force spring, and the base seat is provided with a plurality of holes spaced apart in rows and the two sides of the base seat are provided with a sliding slot, and one end of the pulling force spring is mounted to the base seat of the paddle and the other end is mounted to the wind-blocking board, and the wind blocking board is provided with a plurality of holes which are spaced apart in rows, when the wind-blocking board is located at the sliding slot of the base seat the two holes are not in alignment and when the wind blocking board is away from the pulling force spring, the two holes are stacked to form leakage.

4. The device of claim 1, where the sides of the support body is surrounded by four floats connected to form a center hole which is used to mount to the support body, the upper layer of the float is provided with a transmission mechanism which is connected to a teeth strap by means of a hole, the lower layer of the float is connected to an elongated floating cylinder floats at sea level, and the inner side of the lower layer of the float is provided with pulley to urge one side of the support body.

5. The device of claim 1, wherein the floating cylinder is a flat structure which is sealed to form a liquid chamber and an air chamber, the lower end of the floating cylinder is the liquid chamber to fill sea water, and the upper end is the air chamber, the upper layer of the floating cylinder is connected to a teeth strap and the floating cylinder and the teeth strap are raised and lowered in accordance with the wave.

6. The device of claim 1, wherein the teeth face of the teeth strap is engaged with a top and a bottom gear and a top and a bottom pulley are used to urge the rear of the teeth of the teeth strap, the gear at the top and a free gear are connected coaxially, and the free gear is engaged with a gear and one side of the gear drives a crankshaft to urge an air pump via a linking rod to produce high pressure air energy which is transmitted out by an air delivery tube, the other side of the gear is a fixed shaft having one end fixed to a gear, and one side of the gear drives a crank shaft and via a linking rod to push an air pump to produce high pressure air energy and is delivered out via an air delivery tube, and at the same time, the gear is engaged with another gear and the engaged gear is then engaged with a free gear, the free gear is coaxially connected to a gear and the gear is the lower gear engaged with the gear strap.
